(19) United States
(12) Patent Application Publication
(10) Pub. No.: US 2010/0118575 A1
(43) Pub. Date: May 13, 2010

(54) Power Inverter

(76) Inventor: Stefan Reschenauer, Spannberg (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/527,244

(22) PCT Filed: Jan. 17, 2008
(86) PCT No.: PCT/EP2008/050521

§ 371 Date: Aug. 14, 2009

(30) Foreign Application Priority Data
Feb. 16, 2007 (AT) A247/2007

(51) Int. Cl. H02M 7/06

(52) U.S. Cl. 363/126; 363/132

(57) ABSTRACT

A current inverter including a bridge circuit with four switch elements is provided. Two opposite connector clamps of the bridge circuit are connected to a direct current part of the current inverter, and further two connector clamps of the bridge circuit are connected to an alternating current part of the current inverter. Direct current and alternating current are converted into each other when the switch elements are controlled appropriately. In the direct current part, a first direct current-sided switch element is coupled to a positive direct current clamp, an inductive resistance mounted in series between the first switch element and a first connector clamp and a diode are arranged downstream from the first switch element. A second direct current-sided switch element is mounted in series between the inductive resistance and the diode. A second connector clamp is mounted such that the inductive resistance connects to the second connector clamp.

### CROSS REFERENCE TO RELATED APPLICATIONS

This application is the US National Stage of International Application No. PCT/EP2008/050521 filed Jan. 17, 2008 and claims the benefit thereof. The International Application claims the benefits of Austrian Application No. A247/2007 AT filed Feb. 16, 2007; both of the applications are incorporated by reference herein in their entirety.

### FIELD OF INVENTION

The invention relates to a power inverter comprising a bridge circuit having four switching elements, wherein two oppositely disposed connecting terminals of the bridge circuit are connected to the direct-current (DC) voltage part of the power inverter and the other two connecting terminals of the bridge circuit are connected to the alternating-current (AC) voltage part of the power inverter, wherein DC voltage and AC voltage can be converted from one to the other by suitable driving of the switching elements.

### BACKGROUND OF INVENTION

Power inverters are widely used in electrical engineering, in particular in alternative power generation systems such as, for instance, fuel cell installations and photovoltaic plants (so-called “static systems”) or wind turbine generators (so-called “rotating systems”). In order to feed power into a power supply grid, static systems require a power inverter which converts the incoming DC power into AC power and feeds it in a compatible manner into the power grid. Rotating systems generate AC power, although as a rule this is initially converted into DC power and subsequently is converted back into AC power, on the one hand in order to be able to extend the operating range (e.g. rotational speed range) on the mechanical side of the generator, but on the other hand also to ensure the requisite quality of the AC voltage for feeding into a power supply grid. In this case power inverters enable the electrical parameters on the feed-in side to be separated from those of the grid-side parameters such as frequency and voltage, and thus represent the central link between the feed-in side and the power grid.

According to the prior art use is often made in this case of power inverters comprising a bridge circuit having four switching elements, wherein two oppositely disposed connecting terminals of the bridge circuit are connected to the DC voltage part of the power inverter, and the two other connecting terminals of the bridge circuit are connected to the AC voltage part of the power inverter, wherein DC and AC voltage can be converted from one to the other by suitable driving of the switching elements. However, expensive components such as FRED (Fast Recovery Epitaxial Diode) FETs are usually required in this case for the switching elements of the bridge circuit, since it is sometimes necessary to ensure high switching frequencies. This has a negative impact on the costs of conventional circuit arrangements, and furthermore is detrimental to the efficiency of the conventional power inverters, since unavoidable switching losses are connected with each switching operation.

### SUMMARY OF INVENTION

It is an object of the invention to achieve an increase in efficiency and power quality at lower cost by optimizing the power inverter topology in conjunction with the real-world behavior of the components.

This object is achieved by a power converter as claimed in the claims. The power inverter comprises a bridge circuit having four switching elements, wherein two oppositely disposed connecting terminals of the bridge circuit are connected to the DC voltage part of the power inverter and the two other connecting terminals of the bridge circuit are connected to the AC voltage part of the power inverter, wherein DC voltage and AC voltage can be converted from one to the other by suitable driving of the switching elements. It is provided in this case that in the DC voltage part a first switching element arranged on the DC voltage side is coupled to the positive DC voltage terminal, and disposed downstream thereof between said first switching element and a first connecting terminal of the bridge circuit are a series-connected inductor and a diode. As will be explained in more detail later, a circuit arrangement of this kind enables higher efficiency, since the switching elements of the bridge circuit only need to be switched by means of the power grid frequency, while the current that is to be fed in can be regulated by means of the rapidly pulsed switching elements in the DC voltage part. As a result switching losses are produced on only one switching element, thus substantially increasing the efficiency of the power inverter according to the invention.

An embodiment variant is advantageous in particular when the input voltage on the DC voltage side is less than the maximum value of the AC line voltage on the output side. For this purpose a second, DC-voltage-side switching element is connected in the series circuit between the inductor and the diode on the one side, and a second connecting terminal of the bridge circuit on the other side, said second switching element, in the closed state, connecting the inductor to the second connecting terminal of the bridge circuit. By this means the input voltage on the DC voltage side can be stepped up by suitable switching of the second switching element. Furthermore, the use of a single inductor permits a further cost saving.

Further advantageous developments of the power inverter are specified in the dependent claims. Here, an AC-voltage-side smoothing capacitor is connected in the AC voltage part in each case, and a DC-voltage-side smoothing capacitor is connected in the DC voltage part. It is proposed in addition that the DC-voltage-side switching elements are semiconductor switching elements, in particular power MOSFETs or IGBTs.

### BRIEF DESCRIPTION OF THE DRAWINGS

The invention is explained in more detail below with reference to the accompanying drawings, in which:

FIG. 1 shows the basic circuit diagram of the power inverter according to the invention in a first representation,

FIG. 2 shows the basic circuit diagram of the power inverter according to the invention in a second representation, and

FIG. 3 shows the time characteristic of voltage and control signal for the switching elements when energy flows into the AC voltage part of the power inverter according to the invention.

### DETAILED DESCRIPTION OF INVENTION

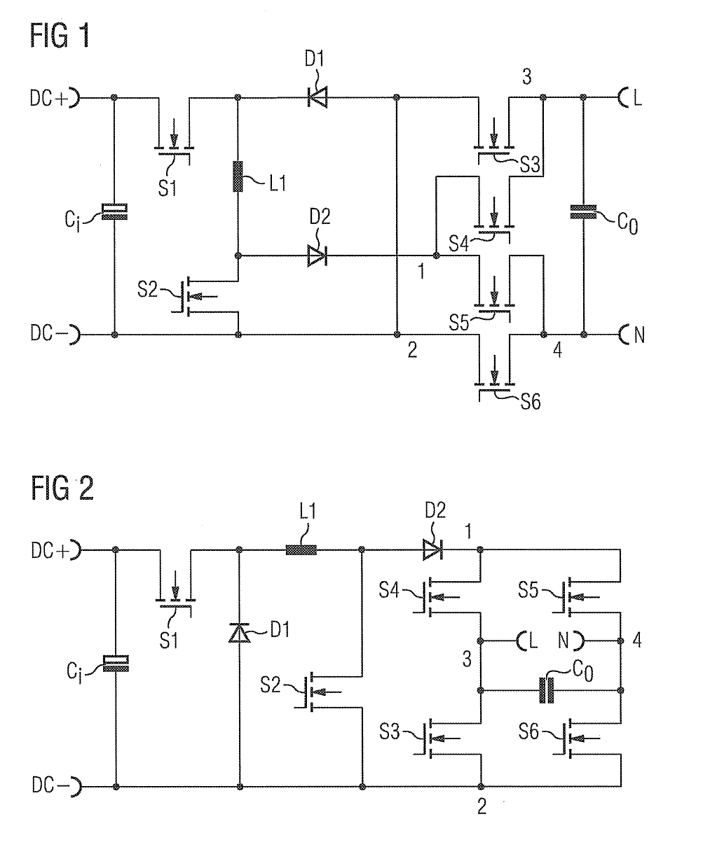

The basic circuit diagram of one embodiment variant of the power inverter according to the invention is initially explained with reference to FIGS. 1 and 2. The power inverter according to the invention has a bridge circuit comprising four switching elements S3, S4, S5 and S6, wherein two oppositely disposed connecting terminals 1, 2 of the bridge circuit are connected to the DC voltage part of the power inverter, and the two other connecting terminals 3, 4 of the bridge circuit are connected to the AC voltage part of the power inverter. The conversion of DC voltage into AC voltage takes place in this arrangement by way of the four switching elements S3, S4, S5 and S6 in the bridge circuit, which constitutes a fall-bridge, wherein DC voltage and AC voltage can be converted one into the other in a per se known manner by suitable driving of the switching elements S3, S4, S5 and S6.

Disposed in the DC voltage part, coupled to the positive DC voltage terminal, is a first switching element S1 on the DC voltage side, downstream of which a series-connected inductor L1 and a diode D2 are arranged between the first switching element S1 and a first connecting terminal 1 of the bridge circuit. Connected in the series circuit between the inductor L1 and the diode D2 on the one side, and a second connecting terminal 2 of the bridge circuit on the other side is a second, DC-voltage-side switching element S2 which, in the closed state, connects the inductor L1 to the second connecting terminal 2 of the bridge circuit. In this arrangement the diode D2 is connected between the positive DC voltage terminal and the first connecting terminal 1 of the bridge circuit in the forward bias direction.

The DC voltage source Uₑ is disposed in the DC voltage part. The load U_{Grid} is disposed in the AC voltage part.

In addition, an AC-voltage-side smoothing capacitor C₀ is connected in the AC voltage part, and a DC-voltage-side smoothing capacitor Cᵢ in the DC voltage part. The switching elements S1, S2, S3, S4, S5 and S6 are preferably semiconductor switching elements, in particular power MOSFETs.

FIG. 2 shows the embodiment variant according to FIG. 1 in an alternative representation.

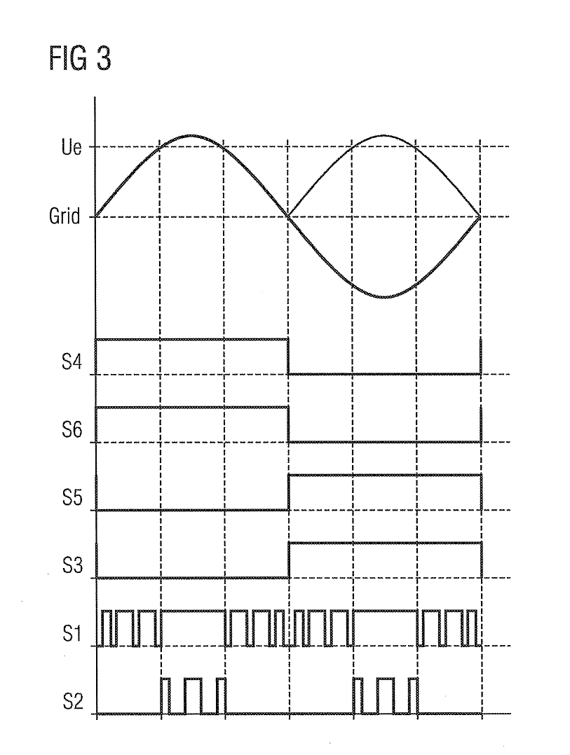

Referring now to FIG. 3, there follows an explanation of the switching sequence for driving the switching elements S1, S2, S3, S4, S5 and S6 when there is a flow of energy from the DC voltage part into the AC voltage part.

First, FIG. 3 illustrates the make phase of the switching sequence during the positive half-wave in the inventive power inverter according to FIG. 1, wherein the energy flows from the DC voltage part into the AC voltage part. The driving of the switching elements and in particular their timing can be found here in the lower diagrams of FIG. 3. As can be seen from FIG. 3, in order to generate the positive half-wave at the output terminals of the AC voltage part the switching elements S4 and S6 remain permanently closed, which is to say conducting, whereas the switching elements S3 and S5 remain permanently deactivated, which is to say non-conducting. As can be seen from FIG. 3, the pulse duty factor is chosen for the rising section of the positive half-wave such that the first, DC-voltage-side switching element S1 is closed as the make time increases, and for the falling section of the positive half-wave as the make time decreases. Thus, the first switching element S1 pulses current into the grid on the DC voltage side by way of the inductor L1 and the diode D2. If the AC line voltage exceeds the DC-voltage-side input voltage, the latter is stepped up with the aid of the second, DC-voltage-side switching element S2. For this purpose the first switching element S1 remains closed, in other words conducting, while a voltage increase is effected by suitable pulsing of the second switching element S2.

In addition a diode D1 can be provided in the DC voltage part, the diode being inserted between the second connecting terminal 2 of the bridge circuit and the first, DC-voltage-side switching element S1, wherein it is connected on the anode side to the second connecting terminal 2 of the bridge circuit, and on the cathode side to the first switching element S1. The freewheeling of the inductor L1 thus takes place by way of the diode D2 connected to the first connecting terminal 1 of the bridge circuit, the load on the AC voltage side, and the diode D1 connected to the second connecting terminal 2 of the bridge circuit.

In order to generate the negative half-wave at the output terminals of the AC voltage parts, the switching elements S3 and S5 are permanently closed, in other words conducting, while the switching elements S4 and S6 remain permanently deactivated, in other words are non-conducting. As can be seen from FIG. 3, in order to generate the positive half-wave at the output terminals of the AC voltage part the switching elements S4 and S6 remain permanently closed, which is to say conducting, whereas the switching elements S3 and S5 remain permanently deactivated, which is to say non-conducting. As can be seen from FIG. 3, the pulse duty factor is chosen for the falling section of the negative half-wave such that the first, DC-voltage-side switching element S1 is closed as the make time increases, and for the rising section of the negative half-wave as the make time decreases. Once again, the first switching element S1 on the DC voltage side pulses current into the grid by way of the inductor L1 and the diode D2. If the AC line voltage exceeds the input voltage on the DC voltage side, the latter can in turn be stepped up with the aid of the second, DC-voltage-side switching element S2. For this purpose the first switching element S1 remains closed, in other words conducting, while a voltage increase for generating the negative maximum value is effected by suitable pulsing of the second switching element S2.

It is apparent in particular from FIG. 3 that in the power inverter topology according to the invention the switching elements S3, S4, S5 and S6 of the bridge circuit only need to be switched by means of the power grid frequency in the zero crossing point. In order to feed in the current, only the first, DC-voltage-side switching element S1 has to be pulsed rapidly, which also means that appreciable switching losses are produced only at said switching element S1. The efficiency of the power inverter according to the invention can thereby be increased substantially at all events, and furthermore up to as much as 98%. Should the input voltage on the DC voltage side be less than the AC line voltage, an additional, second switching element S2 can be used. Furthermore, because of the lower requirements to be met by the switching elements S3, S4, S5 and S6 of the bridge circuit it is also possible to use less expensive components, as a result of which the costs of the overall circuit can be reduced.

1.-5. (canceled)

6. A power inverter, comprising:
a direct current (DC) voltage part;
a alternating current (AC) voltage part;
a bridge circuit including
four switching elements and
four connecting terminals, wherein two oppositely disposed connecting terminals of the bridge circuit are connected to the DC voltage part and the two other connecting terminals are connected to the AC voltage part, and wherein DC voltage and AC voltage are converted from one to the other by suitable driving of the switching elements;
a first DC-voltage-side switching element;
an inductor; and
a diode, wherein the first DC-voltage-side switching element is coupled to a positive DC voltage terminal of the DC voltage part, and wherein the first DC-voltage-side switching element is connected directly to a first connecting terminal of the bridge circuit via the inductor and the diode, the inductor and diode being connected in series.

7. The power inverter as claimed in claim 6, further comprising:
a second DC-voltage-side switching element being connected
in the series circuit between the inductor and the diode, and
to a second connecting terminal of the bridge circuit.

8. The power inverter as claimed in claim 7, wherein the second DC-voltage-side switching element connects in a closed state the inductor to the second connecting terminal of the bridge circuit.

9. The power inverter as claimed in claim 6, further comprising:
an AC-voltage-side smoothing capacitor connected in the AC voltage part.

10. The power inverter as claimed in claim 7, further comprising:
an AC-voltage-side smoothing capacitor connected in the AC voltage part.

11. The power inverter as claimed in claim 6, further comprising:
a DC-voltage-side smoothing capacitor connected in the DC voltage part.

12. The power inverter as claimed in claim 7, further comprising:
a DC-voltage-side smoothing capacitor connected in the DC voltage part.

13. The power inverter as claimed in claim 9, further comprising:
a DC-voltage-side smoothing capacitor connected in the DC voltage part.

14. The power inverter as claimed in claim 7, wherein the first and second DC-voltage-side switching elements are semiconductor switching elements.

15. The power inverter as claimed in claim 14, wherein the first and second DC-voltage-side switching elements are power MOSFETs or IGBTs.
